(19) United States
(12) Patent Application Publication
(10) Pub. No.: US 2025/0369250 A1
(43) Pub. Date: Dec. 4, 2025

(54) FENCING RAIL SPLICING SYSTEM WITH CABLE PASS-THROUGH

(71) Applicant: Alabama Metal Industries Corporation, Birmingham, AL (US)

(72) Inventors: Markus Erbeldinger, Pittsburgh, PA (US); Jerry R. Stevens, Dora, AL (US); Andrew S. Kemp, Bourbonnais, IL (US); Scott B. Galbraith, Bixby, OK (US); Bryan Millican, Trussville, AL (US); Samuel Nganga, Hoover, AL (US)

(21) Appl. No.: 19/220,225

(22) Filed: May 28, 2025

Related U.S. Application Data
(60) Provisional application No. 63/652,830, filed on May 29, 2024.

(51) Int. Cl. E04H 17/14

(52) U.S. Cl. CPC E04H 17/1473

(57) ABSTRACT

A fencing system includes a rail member having a slot. The rail member is configured to extend between adjacent posts of the fencing system. A splicing rail includes a channel and a flexible tab. With an end portion of the rail member received along the channel of the splicing rail, the flexible tab of the splicing rail flexes at least partially into the channel of the splicing rail and at least partially within the slot of the rail member to preclude the rail member from pulling out of the channel of the splicing rail.

### CROSS REFERENCE TO RELATED APPLICATION

The present application claims the filing benefits of U.S. provisional application Ser. No. 63/652,830, filed May 29, 2024, which is hereby incorporated herein by reference in its entirety.

### TECHNICAL FIELD

The present disclosure generally relates to rails for a fencing system and, more particularly, to a system for splicing ends of rails.

### BACKGROUND

A fence is a structure that encloses an area, typically outdoors. There are many perimeter fencing solutions commercially available. Generally, a fence around a property or area involves installing in the ground a number of posts spaced apart to receive individual connecting rails and optionally fence panels and/or wires. A fence differs from a wall in that the fence typically does not have a solid foundation along its whole length.

### SUMMARY

A fencing system may include one or more posts configured to be anchored to the ground and one or more horizontal connecting rails extending between respective posts. The horizontal rails define channels, such as for receiving cables or electrical wires or the like therealong, and include slots or holes formed through respective sides of the horizontal rails, such as for attaching fence panels or vertical slats. Respective end portions of the horizontal rails may be supported at the posts and may be joined together or secured relative to one another to provide continuity between the adjacent horizontal rails. Optionally, the end portions of the horizontal rails may be secured relative to one another at positions between adjacent posts to provide a longer spanning horizontal rail between the posts.

For example, a splicing rail may be supported at the post, such as along a passageway of the post or along a passageway of a bracket attached at the post. The splicing rail includes a channel having a profile that corresponds to the channel of the horizontal rail and the channel receives end portions of adjacent horizontal rails. The splicing rail further includes flexible tabs formed or cut at the side of the splicing rail. With the horizontal rails received along the channel of the splicing rail, the tabs are flexed inward toward the channel and at least partially within slots of the horizontal rails to preclude or prevent the horizontal rails from moving or pulling out of the channels of the splicing rails. Thus, the splicing rail provides an external splicing system that does not interfere with or obstruct the channels of the horizontal rails, allowing cables or electrical wires or other components to extend between adjacent horizontal rails and along the length of the fencing system.

These and other objects, advantages, purposes and features of the present invention will become apparent upon review of the following specification in conjunction with the drawings.

### BRIEF DESCRIPTION OF THE DRAWINGS

FIG. 1 is an environmental view of a fencing system configured to receive a cable extending along the channel of a horizontal rail;

FIGS. 2-4 are views of the horizontal rail of the fencing system;

FIGS. 5-8 are views of two horizontal rails received along a channel of a splicing rail of the fencing system;

FIG. 8A is a sectional view taken along line A-A of FIG. 8;

FIGS. 9 and 10 are views of the splicing rail of the fencing system;

FIG. 11 is an end view of an inner splicing rail received along the channel of the horizontal rail of the fencing system;

FIGS. 12 and 13 are views of a bracket configured to attach to a vertical post of the fencing system and configured to receive the horizontal rail;

FIG. 14 shows a rail blocker plate of the bracket;

FIGS. 15 and 16 are views of the bracket with the horizontal rail received along a passageway of the bracket and a cable received along the channel of the horizontal rail;

FIGS. 17-21 show the horizontal rail and cable being installed at the bracket; and

FIGS. 22-27 are views of the fencing system with the horizontal rail and cable disposed at the vertical posts via the bracket.

### DETAILED DESCRIPTION

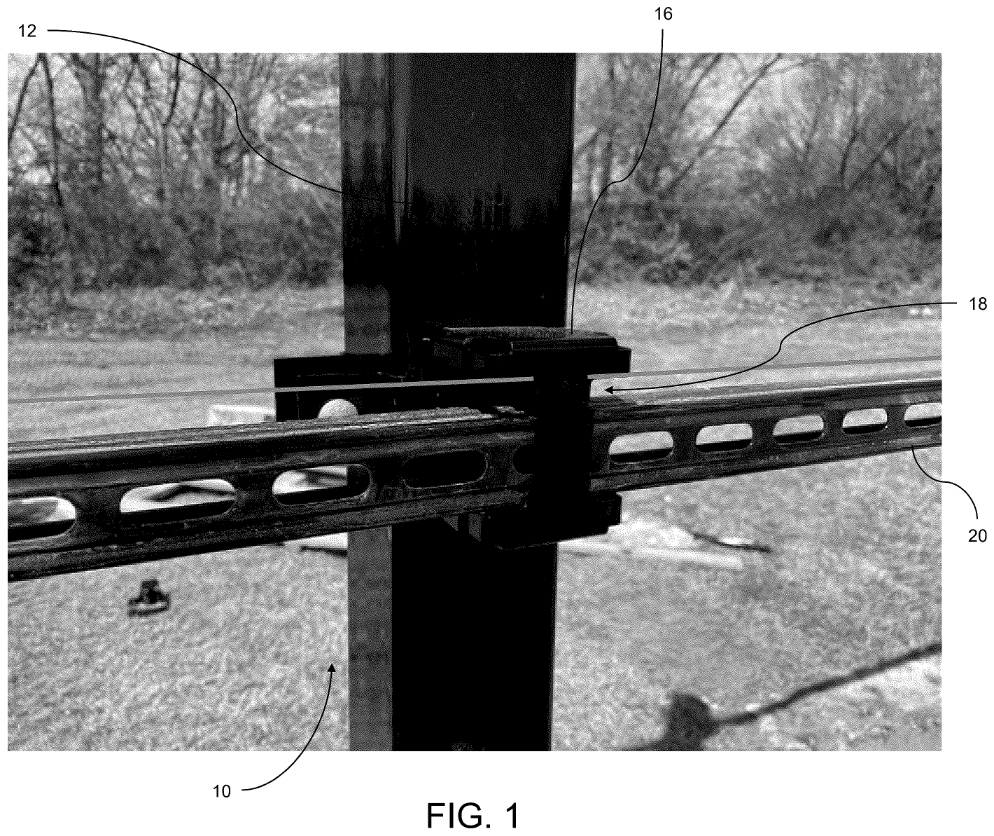

Referring now to the drawings and the illustrative embodiments depicted therein, a fencing system 10 may include a series of vertical posts 12 anchored to a ground surface, such as a concrete slab, a concrete footing, or earth, and spaced from one another, with horizontal connecting rails 20 extending between respective ones of the vertical posts (FIG. 1). In some examples, the vertical posts 12 include horizontal passageways extending through the posts 12 that are configured to receive at least a portion of the horizontal connecting rail 20 therethrough. For example, respective end portions 20a of adjacent horizontal connecting rails 20 may be received along the passageway to give the appearance of a continuous or seamless connecting rail 20 extending between the vertical posts 12 of the fencing system 10. The horizontal connecting rail 20 may also fully pass through the passageways of one or more vertical posts 12. In the illustrated example, a bracket 16 mounts to the vertical post 12 and includes a passageway 18 configured to receive the horizontal connecting rail 20 or end portions 20a of adjacent connecting rails 20. Fence panels (not shown) may be supported at the vertical posts 12 and/or the horizontal connecting rails 20 and extend between the vertical posts 12 to form a continuous barrier. For example, two or more horizontal connecting rails 20 (e.g., an upper rail and a lower rail) may extend between adjacent vertical posts 12 and the fence panel or other barrier may be supported by the horizontal connecting rails 20 and optionally the vertical posts 12. Optionally, vertical slats or rails may be supported at the horizontal connecting rails 20 and arranged between the vertical posts 12 to form a semi-continuous barrier. The fencing system 10 may be installed along the perimeter of a property or surrounding a restricted area, such as a power transformer or construction site, to prevent unauthorized crossing of the barrier. The fencing system may include characteristics of the fencing systems described in U.S. Pat. Nos. 11, 180,928 and/or 10,221,586, and/or U.S. Pat. Pub. Nos. US-2022-0074228 and/or US-2021-0340789, and/or U.S. patent application Ser. No. 19/202,318, filed May 8, 2025 (Attorney Docket AMICO P142A), which are hereby incorporated herein by reference in their entireties.

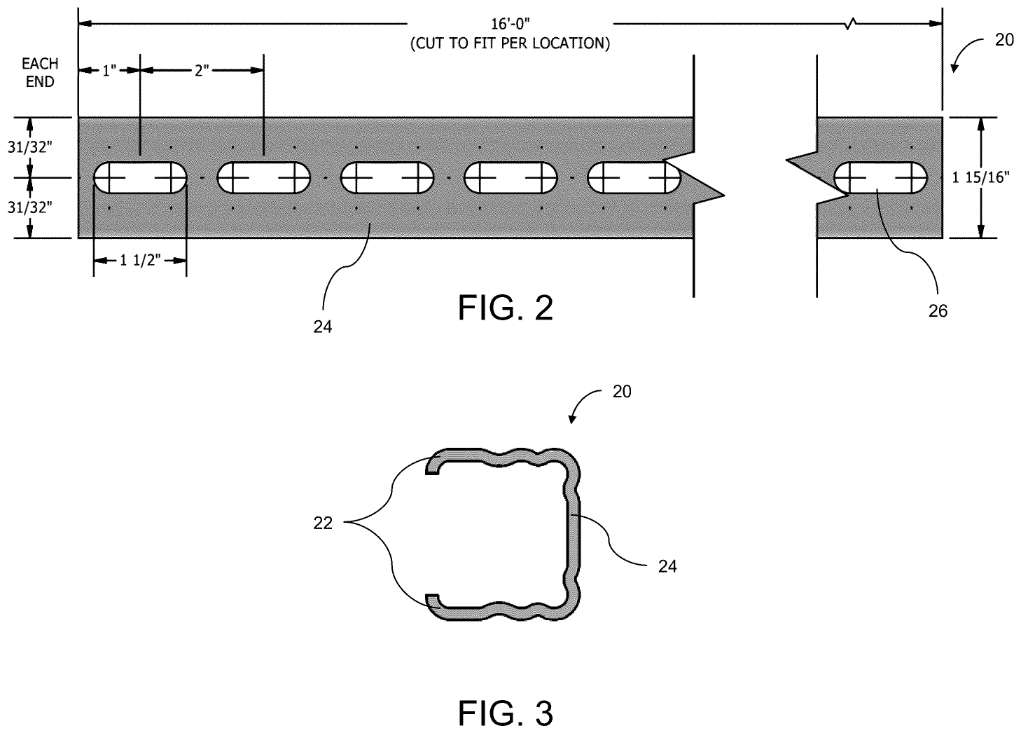

As shown in FIGS. 2-4, the horizontal connecting rails 20 may be generally C-shaped with a pair of legs 22 extending from opposing sides of a base portion 24 to define a channel of the horizontal connecting rail 20. Slots or openings 26 are formed through the base portion 24, such as uniformly spaced from one another along the length of the rail 20, for attaching fence panels or vertical slats to the horizontal connecting rails 20. For example, a clip or threaded fastener may extend through the fence panel or vertical slat and one of the slots 26 for attaching the panel or slat to the fencing assembly 10. A space or gap between the ends of the legs 22 may provide access to the channel of the rail 20, such as to allow a user to thread a receiver onto the end of the threaded fastener attaching the panel to the horizontal rail 20.

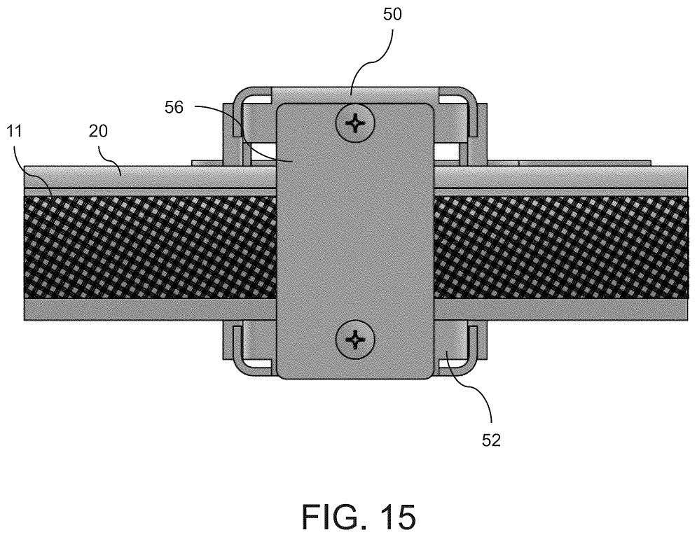

In some examples, one or more cables 11 (FIG. 15) may be inserted into the channel of the horizontal rail 20, such as via the lengthwise or lateral opening between the legs 22, and extend along the length of fencing system 10 and between adjacent rails 20. For example, electrical wires may extend along the rails 20 to deliver electrical power along the fencing system 10 (e.g., for gate opening systems or surveillance systems and the like). Optionally, the cable 11 may be a braided metal cable as part of a crash mitigation system, where the cable 11 resists forces (e.g., from a vehicle driving into the fencing system) that may cause the rails 20 and/or posts 12 to bend, break, or separate from one another. Thus, to accommodate the cable 11 along the channel of the rail 20, the channel must be kept relatively clear of interfering objects or connectors.

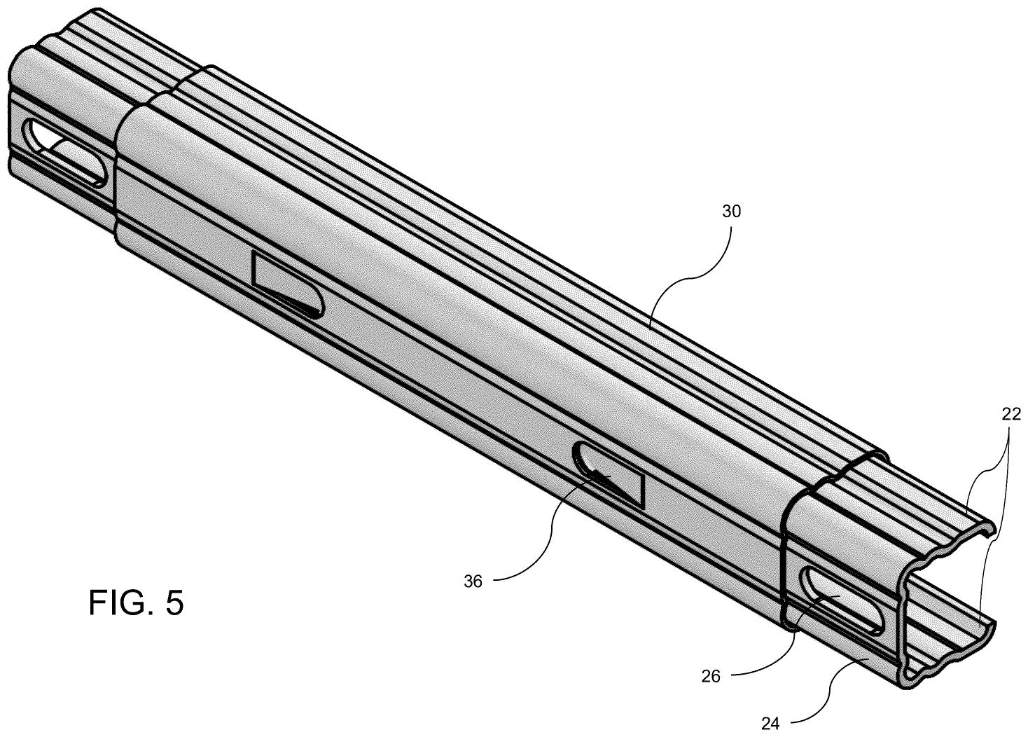

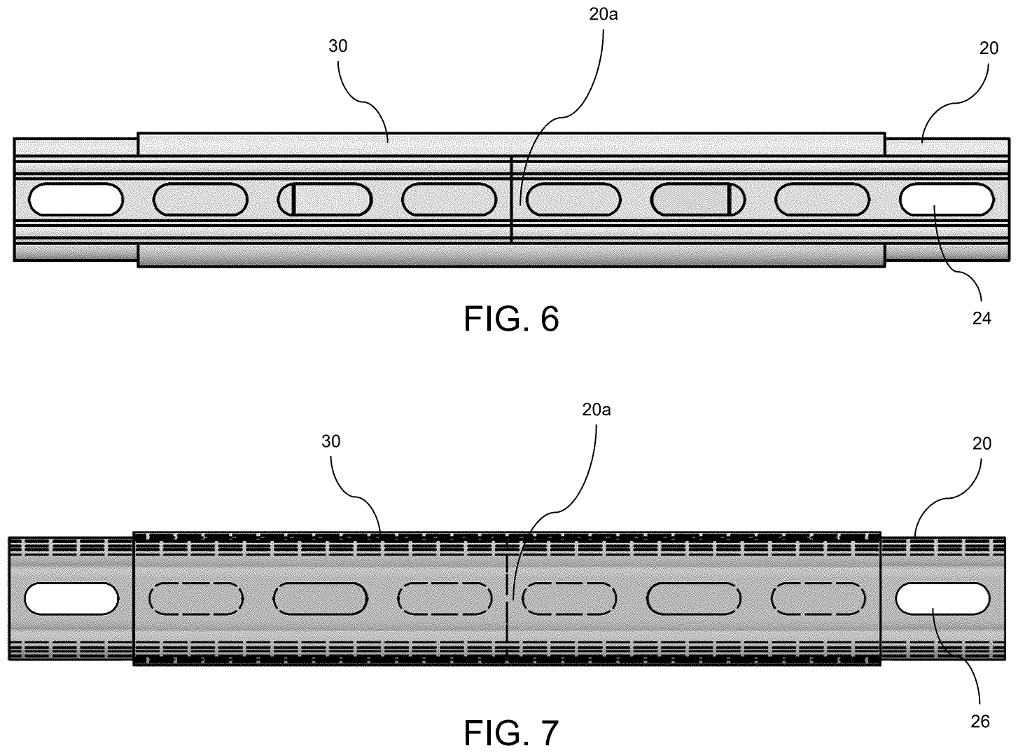

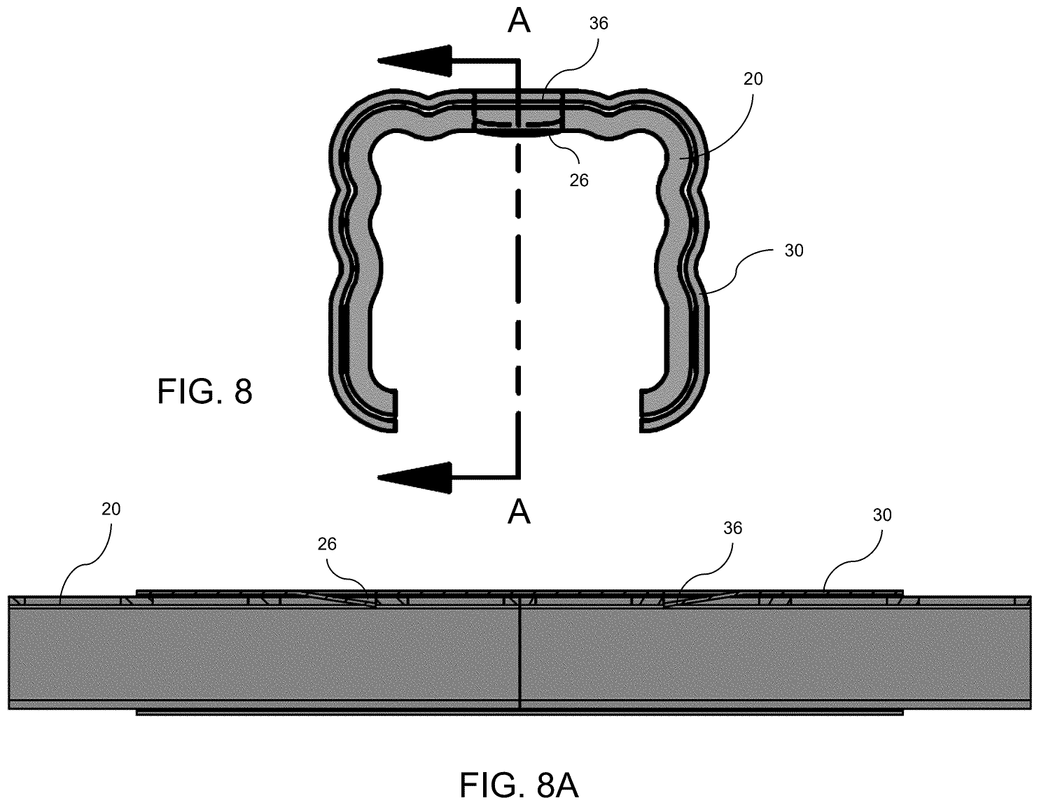

Referring to FIGS. 5-10, a connector or splicing rail 30 may receive end portions 20a of adjacent rails 20 to secure the rails 20 relative to one another and provide a relatively seamless or continuous joint between the adjacent rails 20. For example, with the end portions 20a of the two rails 20 received along the splicing rail 30, the splicing rail 30 may be at least partially disposed along the passageway of the vertical post 12 or the passageway 18 of the bracket 16 to secure the horizontal rails 20 relative to the vertical post 12 and allow the horizontal rails 20 to extend on opposing sides of the vertical post 12. As discussed further below, the splicing rail 30 is disposed exterior the horizontal rails 20 to avoid interfering with the cable 11 or other components disposed within the channel of the rails 20.

The splicing rail 30 may be generally C-shaped with a pair of legs 32 extending from opposing sides of a base portion 34 to define a channel of the splicing rail 30. Because the horizontal rails 20 are received along the channel of the splicing rail 30, the splicing rail 30 may be shaped or contoured to correspond to shapes or contours of the horizontal rails 20. For example, the legs 22 of the horizontal rail 20 may have a wavy or ridged shape and the legs 32 of the splicing rail 30 have a corresponding wavy or ridged shape configured to receive the horizontal rail 20. Similarly, the base portion 24 of the horizontal rail 20 may include detents or indentations and the base portion 34 of the splicing rail 30 may have corresponding detents or indentations for receiving the horizontal rail 20. The matching surface shapes of the horizontal rail 20 and the splicing rail 30 may aid in forming a friction fit and securing the horizontal rails 20 relative to the splicing rail 30. The horizontal rail 20 and the splicing rail 30 may be configured to have a uniform or substantially uniform gap between the outer surfaces of the horizontal rail 20 and the inner surfaces of the splicing rail 30 when fit together, such as about 0.031 inches or the like.

Further, the base portion 34 of the splicing rail 30 includes one or more, or two or more, bendable tabs 36 that are configured to bend or flex relative to the base portion 34 and at least partially into the channel of the splicing rail 30 to engage the horizontal rail 20 and prevent or preclude the horizontal rail 20 from pulling out of the splicing rail 30. For example, the tabs 36 may include generally C-shaped tabs that are spaced apart along the base portion 34 and dimensioned to be received at least partially within corresponding slots 26 of the rails 20. The tabs 36 may be cut, such as laser cut, from the base portion 34.

With the rails 20 received along the channel of the splicing rail 30, the tabs 36 may be bent or flexed inward and at least partially into respective slots 26 to engage and restrict movement of the rails 20. The tabs 36 may be pointed toward a central portion of the splicing rail 30 so that, during assembly, the tab (which may be biased toward a bent or inwardly angled state) may flex as the rail is inserted into the splicing rail and slide along the inserted rail until the tab aligns with a respective slot, whereby the tab may return toward the bent or inwardly angled state within the respective slot. With the tabs 36 flexed into the channel (in their bent or inwardly angled state), the horizontal rail 20 may be moved into and along the channel of the splicing rail 30 with the tabs 36 moving along the horizontal rail 20 until they reach and flex into the respective slots 26. Movement of the horizontal rail 20 in the opposite direction out of the channel of the splicing rail 30 would cause the tab 36 to catch within the slot 26 and prevent or preclude further movement of the horizontal rail 20.

In other words, the flexible tabs 36 may each have a trailing edge that is at least partially disconnected or cut from the base portion 34 of the splicing rail 30 and a leading edge that is at least partially connected to or integrally formed with the base portion 34 of the splicing rail 30. The tabs 36 flex at the leading edge to move the trailing edge into and out of the channel of the splicing rail 30. As shown in FIG. 5, the flexible tabs 36 at opposing ends of the splicing rail 30 are pointed in opposite directions and toward one another so that the trailing edges are closest to one another and the leading edges are furthest from one another. Accordingly, when one rail member 20 is inserted into an end of the channel of the splicing rail 30 in a first insertion direction, the trailing edge may engage and move along the rail member 20 and one or more slots 26 with the leading edge flexing to accommodate movement of the trailing edge into and out of the slots 26. With the trailing edge disposed within a slot 26, movement of the one rail member 20 in a direction opposite the first insertion direction causes the trailing edge to engage the rail member 20 to preclude further movement of the rail member 20 in that direction. The other rail member 20 may be inserted into the opposite end of the splicing rail 30 in a second insertion direction opposite to the first insertion direction so that the other tab 36 flexes to accommodate movement of the other rail member 20 into the splicing rail 30 and catches a slot of the rail member 20 if moved out of the splicing rail 30. The C-shaped tabs 36 are thus pointed in the insertion direction of the rail member 20 to allow insertion into the channel and preclude pulling out of the rail member 20 from the channel of the splicing rail 30.

Thus, the splicing rail 30 receives the adjacent horizontal rails 20 and secures the rails 20 relative to one another without interfering with the channels of the horizontal rails 20, such that the cable 11 and/or other wires or devices may be disposed within the channels of the horizontal rails 20 and spanning the fencing system 10. The splicing rail 30 may only be disposed at the end portions 20a of the horizontal rails 20, such that fence panels or vertical slats may be affixed at the slots 26 along other portions of the horizontal rails 20. Further, the splicing rail 30 may be received along the passageway of the vertical post 12 or the passageway 18 of the bracket 16 to attach the horizontal rails 20 at the vertical posts 12 in a substantially seamless and continuous manner.

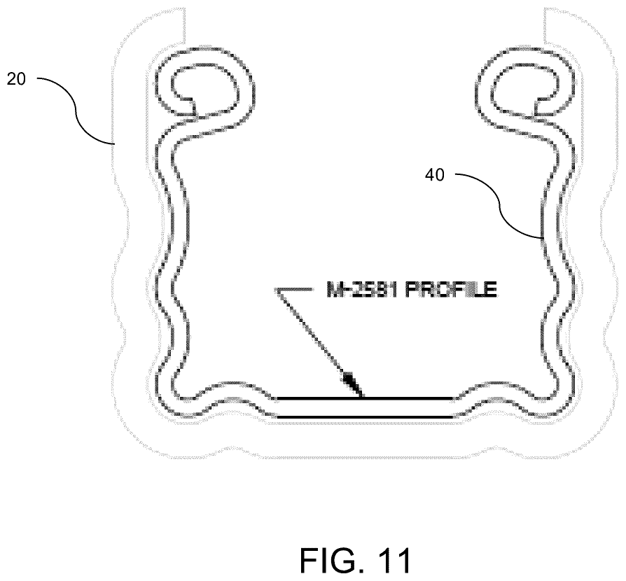

Optionally, and such as shown in FIG. 11, a smaller splicing rail or inner splicing rail 40 may be received along the channels of adjacent horizontal rails 20 to secure the rails 20 relative to one another. That is, the inner splicing rail 40 may be generally C-shaped and have a shape or profile that generally corresponds to the inner shape or profile of the channel of the horizontal rail 20 so that, with the inner splicing rail 40 received along the channels of the adjacent horizontal rails 20, the inner splicing rail 40 forms a friction fit with the horizontal rails 20. The inner splicing rail 40 may be utilized to join adjacent horizontal rails 20 when, for example, no cable (or a cable having smaller dimensions) is received along the channel of the horizontal rails 20, or when the passageway of the vertical post 12 or passageway 18 of the bracket 16 is not able to accommodate an external splicing component.

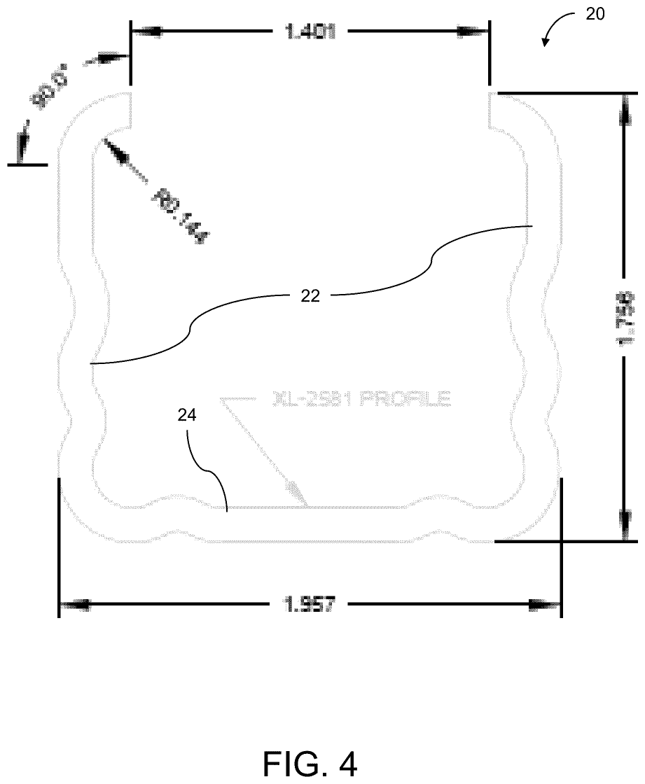

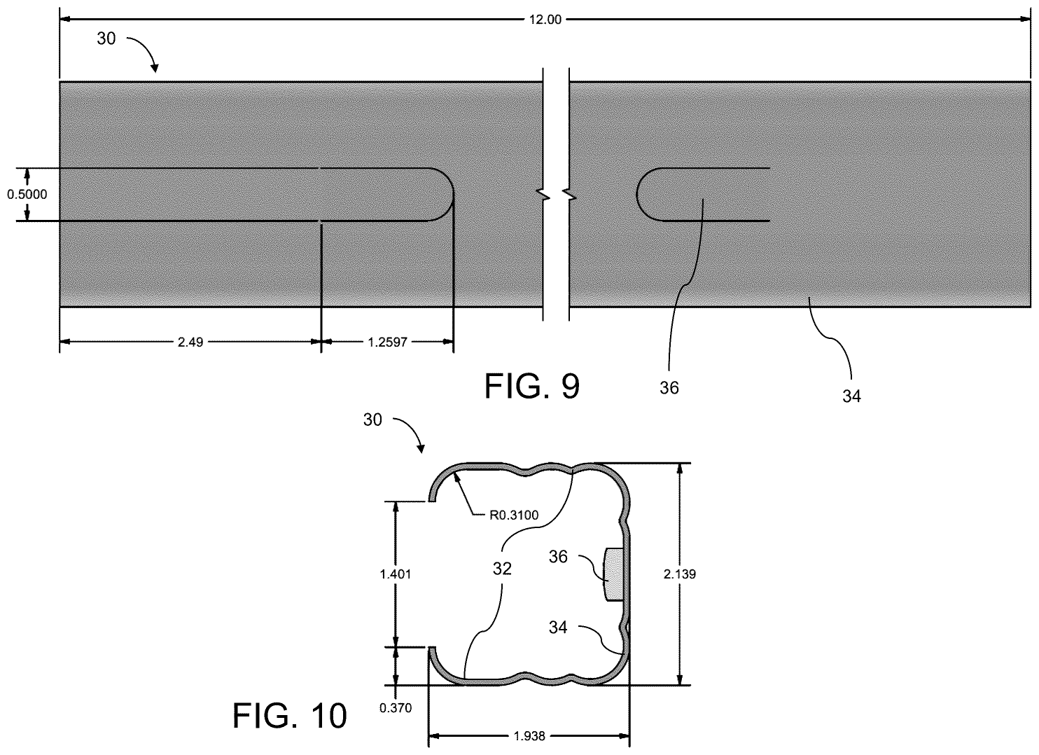

FIGS. 2, 4, 9 and 10 include example dimensions of the splicing system. For example, the horizontal rail 20 may be formed, such as die cut, to any suitable dimensions. In the illustrated example of FIGS. 2 and 4, the horizontal rail 20 has a length of 16 feet, with a width (i.e., between outer surfaces of the legs 22) of about 1.9375 inches or 1.957 inches or the like, and a depth (i.e., between the outer surface of the base portion 24 and the ends of the legs 22) of about 1.756 inches or the like. The ends of the legs 22 may be at least partially turned or bent or curved inward toward one another, such as by 90 degrees with a radius of curvature of about 0.144 inches and leaving an opening to the channel of the horizontal rail 20 of about 1.401 inches or the like. Further, the slots 26 may be about 1.5 inches long and arranged to have centers spaced 2 inches apart, with the outermost slots 26 having centers arranged 1 inch from the ends of the rails 20. In the illustrated example of FIGS. 9 and 10, the splicing rail 30 has a length of 12 inches, with a width (i.e., between outer surfaces of the legs 32) of about 2.139 inches or the like, and a depth (i.e., between the outer surface of the base portion 34 and the ends of the legs 32) of about 1.938 inches or the like. The ends of the legs 32 may be at least partially turned or bent or curved inward toward one another, such as by 90 degrees with a radius of curvature of about 0.31 inches and leaving an opening to the channel of the splicing rail 30 of about 1.401 inches or the like. The tabs 36 may be about 1.2597 inches long with a width of about 0.5 inches. The tab 36 may begin about 2.49 inches from the end of the splicing rail 30 to position the tab 36 for engaging the corresponding slot 26 of the horizontal rail 20. The horizontal rail 20, the splicing rail 30, and other portions of the fencing system 10 may be manufactured from any suitable material, such as metal (e.g., 16 gauge steel or aluminum), injection mold plastic, and/or via additive manufacturing techniques like 3D printing.

Thus, the splicing rail 30 receives the horizontal rail 20 along the channel of the splicing rail 30 and engages flexible tabs 36 with corresponding slots 26 of the horizontal rail 20 to provide an external splicing or joining system. This allows cables or other components to extend along the horizontal rails 20 along the fencing system 10, such as to provide electrical power, added structural support, and/or a crash mitigation system. The bendable tabs 36 thus allow installation of the cable 11 without separate fasteners. Further, the cut-out tabs may be easier to manufacture than other, push-pin style fasteners.

As shown in FIG. 1, with the bracket 16 attached to the post 12 and the horizontal rail 20 and/or splicing rail 30 extending through the passageway 18 of the bracket 16, the cable may be inserted into the passageway of the rail 20. At portions of the rail 20 between the vertical posts 12, the cable may be inserted into the rail 20 through the lengthwise opening between the legs 22 of the rail 20 (i.e., in a direction perpendicular to the longitudinal axis of the rail 20). To extend the cable along portions of the rail 20 disposed at the passageway 18 of the bracket 16, the cable is threaded through the portion of the rail 20 extending along the passageway 18 of the bracket 16 (i.e., in a direction parallel to the longitudinal axis of the rail 20). For lightweight cables or fence systems spanning a relatively short distance (e.g., about 100 feet or less or about 40 feet or less), this may not prove difficult for the installer. However, this may be a difficult or time consuming task for heavier cables and/or longer spans of fence.

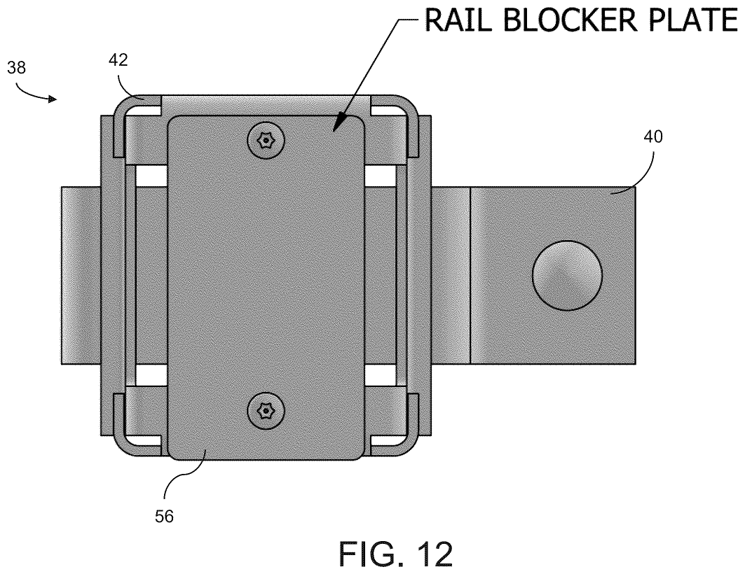

Optionally, a bracket mounted to the vertical post may be configured to receive the horizontal rail and/or splicing rail and allow access to the lengthwise opening of the rail for easier installation of the cable along the rail. For example, and referring to FIGS. 12-21, a bracket 38 may include a clamping portion 40 configured to attach to the vertical post 12 and a retaining portion 42 configured to receive the rail 20 and/or splicing rail 30 and the cable 11 and capture or retain the rail 20 and/or splicing rail 30 and cable 11 at the bracket 38 and vertical post 12.

The clamping portion 40 includes a rigid band 44, such as a sheet metal band, that wraps at least partially about the vertical post 12 so that opposing ends of the band 44 are disposed at the same side of the post 12 and oppose one another. A fastener 46, such as a threaded bolt with corresponding threaded receiver, may extend between the opposing ends of the band 44. Tightening the fastener 46 brings the two ends of the band 44 toward one another to tighten the band 44 about the post 12 and secure the bracket 38 to the vertical post 12. Optionally, additional fasteners may be used to secure the position of the bracket 38 along the post 12, such as a tap screw or other threaded fastener that extends through an aperture in the band 44 and is received by a corresponding hole or receiver at the post 12. Further, the band 44 may comprise a shape that corresponds to an outer shape of the vertical post 12, such as a square or rectangular shape or a circular or rounded shape.

The retaining portion 42 includes a generally C-shaped bracket having a base portion 48 attached to a portion of the band 44 and having an upper leg 50 and a lower leg 52 extending away from the base portion 48 and away from the band 44. For example, the base portion 48 may be welded to the band 44 or attached to the band 44 in any suitable manner, such as via threaded fasteners, adhesive and the like.

The C-shaped bracket has a channel or receiving portion 54 with an open end facing away from the band 44. With the clamping portion 40 attached at the vertical post 12, the open end of the retaining portion 42 may face away from the fence panel or vertical slats attached between the vertical posts 12. The horizontal rail 20 and/or splicing rail 30 may be disposed within the receiving portion 54. The upper leg 50 and the lower leg 52 may each include structure, such as a tab or extension folded over the respective leg, to reinforce the leg 52. Thus, with the horizontal rail 20 received along the receiving portion 54, the horizontal rail 20 may rest on and be supported by the lower leg 52.

With the horizontal rail 20 disposed within the receiving portion 54, a rail blocker plate 56 may be disposed at the retaining portion 42 and extend between the upper leg 50 and the lower leg 52 to cover the open end of the channel and retain the horizontal rail 20 at the bracket 38. For example, the rail blocker plate 56 may comprise a rigid plate attached to the upper leg 50 and the lower leg 52 via threaded fasteners.

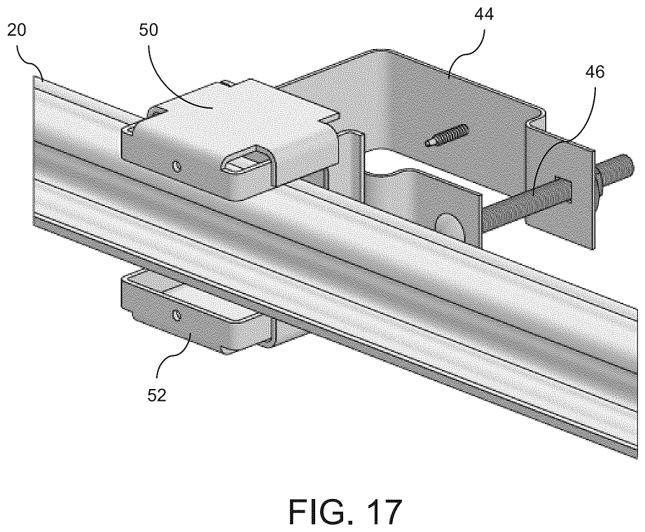

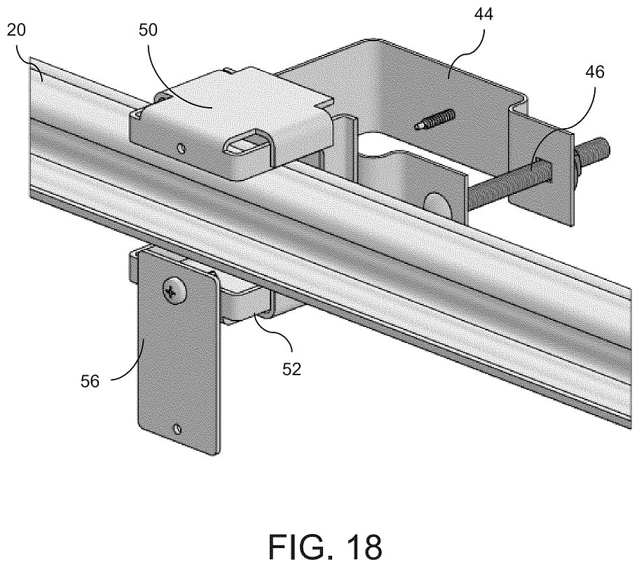

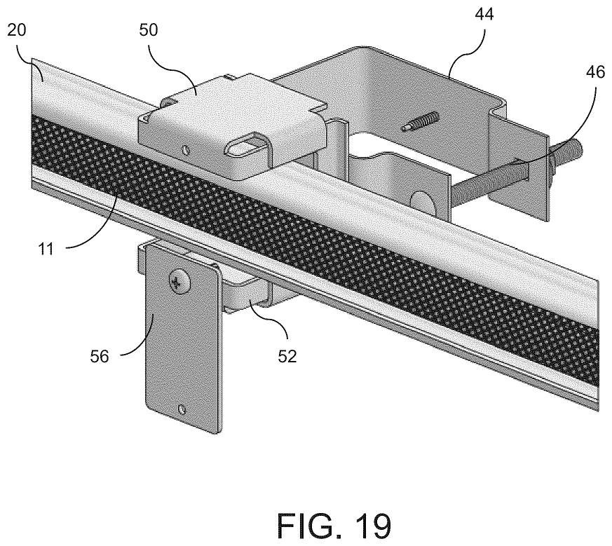

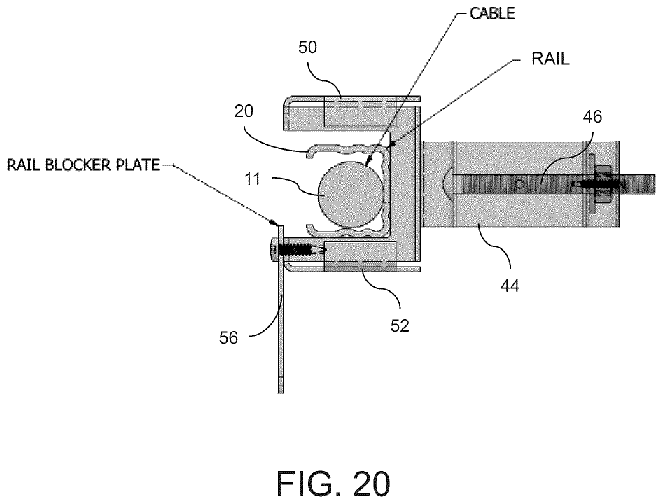

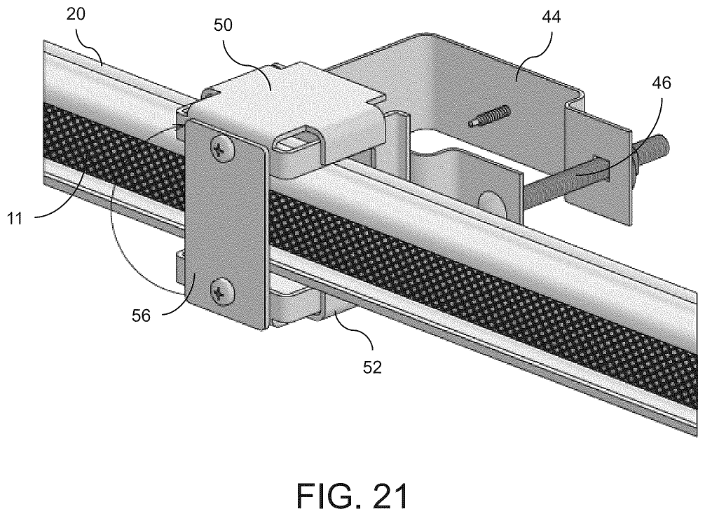

Thus, with the vertical post 12 anchored to the ground surface, the clamping portion 40 of the bracket 38 may be disposed at the vertical post 12 by at least partially wrapping the band 44 about the post 12. The fastener 46 may extend between the opposing ends of the band 44 and is tightened to secure the bracket 38 at the vertical post 12. With the rail blocker plate 56 moved away from the open end of the channel of the retaining portion 42, the horizontal rail 20 may be inserted into the receiving portion 54 of the bracket 38 (FIG. 17). With the horizontal rail 20 received at the bracket 38, the lengthwise opening of the rail 20 is accessible at the bracket 38 and receives the cable 11 (FIGS. 19 and 20). The rail blocker plate 56 may then be attached to the retaining portion 42 of the bracket 38 to cover the open end of the channel and retain the rail 20 and cable 11 at the bracket 38. For example, a first end portion of the plate 56 may be attached at one of the upper leg 50 and the lower leg 52 of the retaining portion 42, such as via a threaded fastener (FIGS. 18-20). Then, the rail blocker plate 56 may be moved to cover the open end of the channel and an opposing second end portion of the plate 56 may be attached at the other of the upper leg 50 and the lower leg 52, such as via another threaded fastener (FIG. 21).

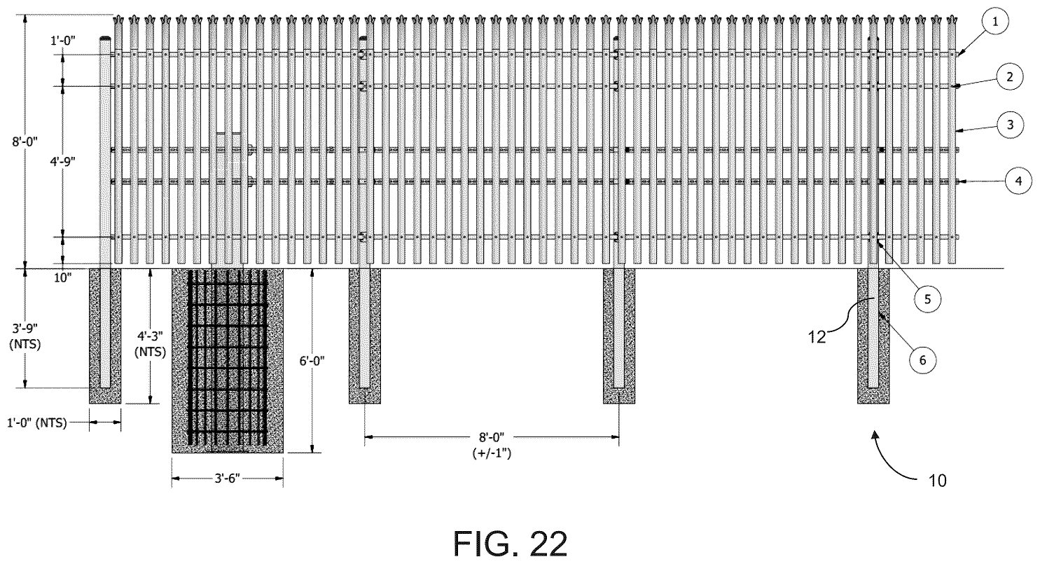

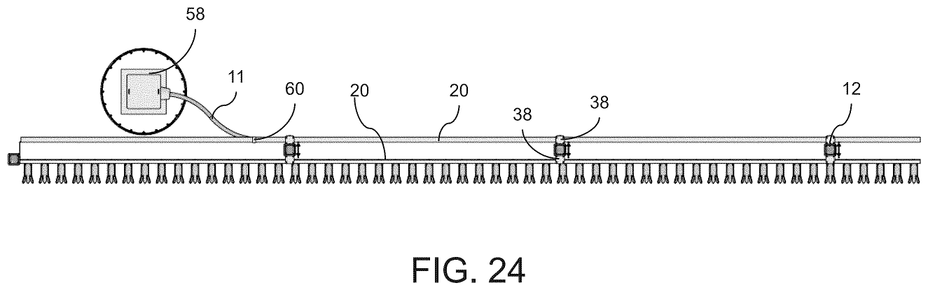

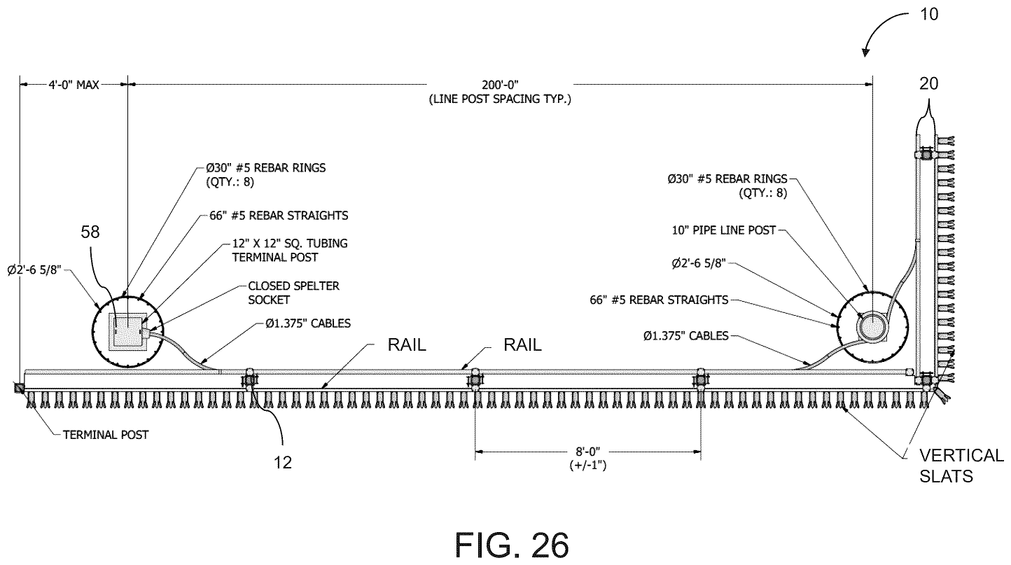

In some examples, and such as shown in FIGS. 22-27, two or more sets of horizontal rails 20 may be disposed or attached to the vertical posts 12. For example, a first set of horizontal rails 20 may be configured to receive the vertical slats or fence panels that extend between the vertical posts 12 to provide the barrier of the fencing system 10 and a second set of horizontal rails 20 may be configured to receive respective cables 11 to provide the crash mitigation of the fencing system 10. In the illustrated example, the first set of horizontal rails 20 are supported at the vertical posts 12 by a first set of brackets 38 that have the retaining portion 42 at a first side of the fencing system 10 and the second set of horizontal rails 20 are supported at the vertical posts 12 by a second set of brackets 38 that have the retaining portion 42 at an opposing second side of the fencing system 10 (FIG. 24). Thus, the rails 20 supporting the crash mitigation cable 11 are spaced from the rails 20 and the fence panels or vertical slats, preventing the rails from being used as a stepping point for an intruder trying to climb the fence. Further, the horizontal rails supporting the crash cable 11 and the horizontal rails supporting the fence barrier may be vertically spaced from one another along the posts 12.

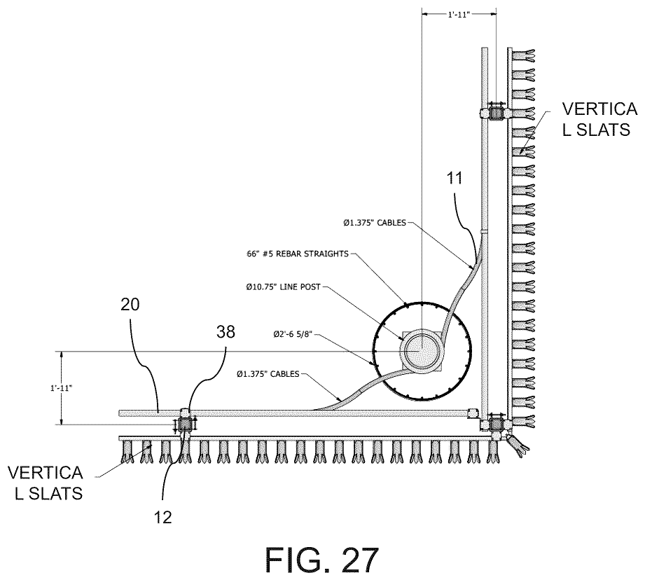

Thus, the vertical posts 12 may receive two or more sets of brackets 38 having channels or retaining portions 42 at different sides of the vertical post 12. For example, the square or rectangular vertical posts 12 may receive brackets 38 that face away from opposing sides of the posts 12 to support fence panels or vertical slats and crash mitigation rails at opposing sides of the fence 10. In some examples, the post 12 may support brackets 38 at three or more sides, or four or more sides, such as to enable corners or angled portions of the fence (FIG. 27). Optionally, the horizontal rails 20 supporting the fence barrier extend through passageways formed through the vertical posts 12.

The cables 11 may be anchored to terminal posts 58 spaced from the fencing system 10. The cables 11 extend from the terminal posts 58 and are received along the lengthwise channels of the horizontal rails 20. Clips or bands 60 may be attached to the horizontal rails periodically along the rails 20 to retain the cables 11 along the rails 20, with the rail blocker plates 56 further retaining the cables 11 in the rails 20.

Thus, the bracket 38 mounted to the vertical post 12 and receiving the cable 11 along the horizontal rail 20 provides a crash mitigation fencing system that allows for heavy, long and strong cables to be integrated into the fence without sacrificing the diameter of the cable or the length of the fence. Further, the durability of the vertical post 12 is not compromised by passageways or cutouts formed in the post. The cable 11 is easy to install at the bracket 38 and, once installed, the cable is spaced from and does not touch the fencing infill, thus eliminating a potential step hazard that intruders might otherwise use for climbing the fence.

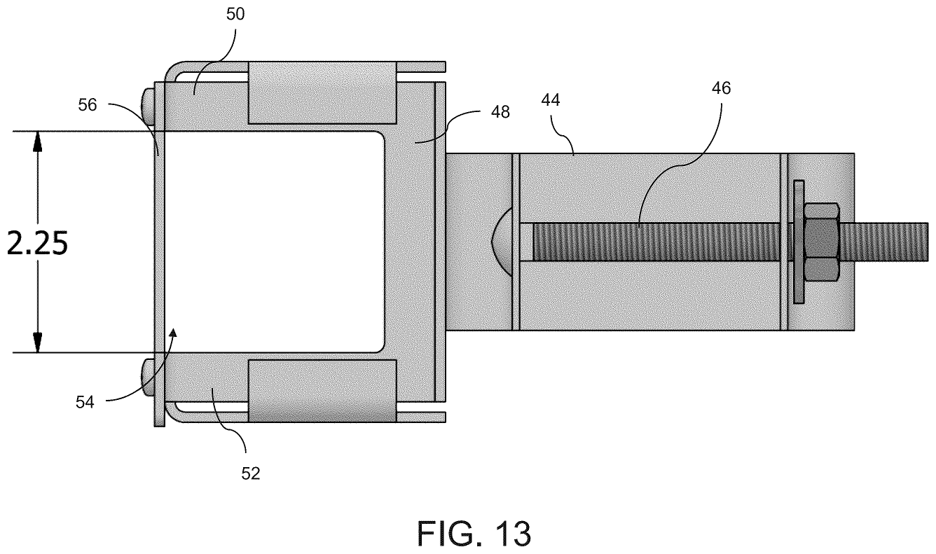

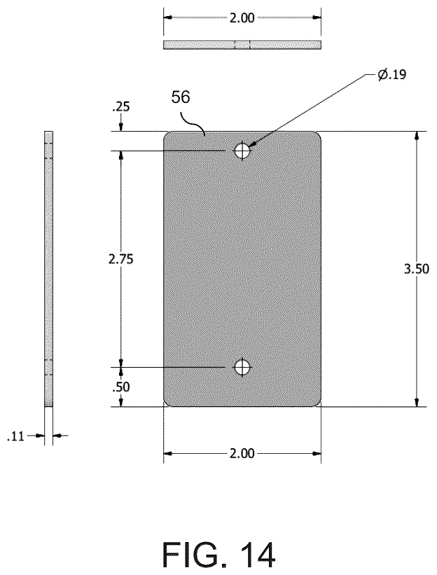

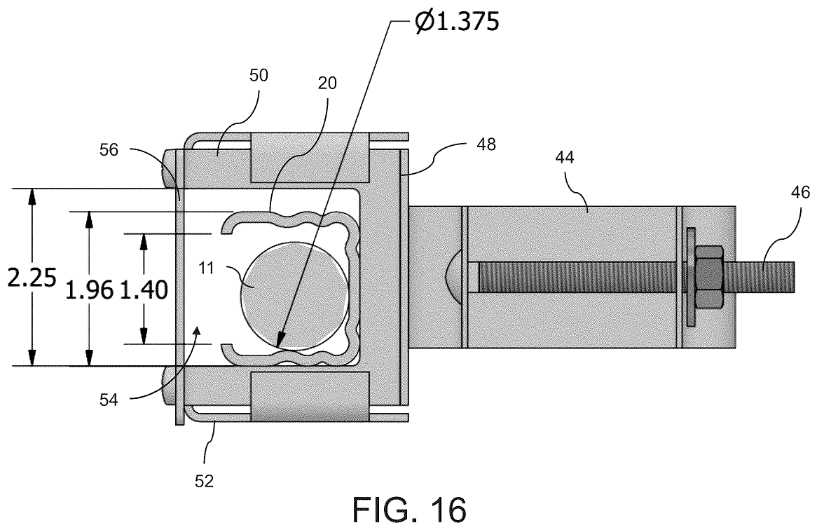

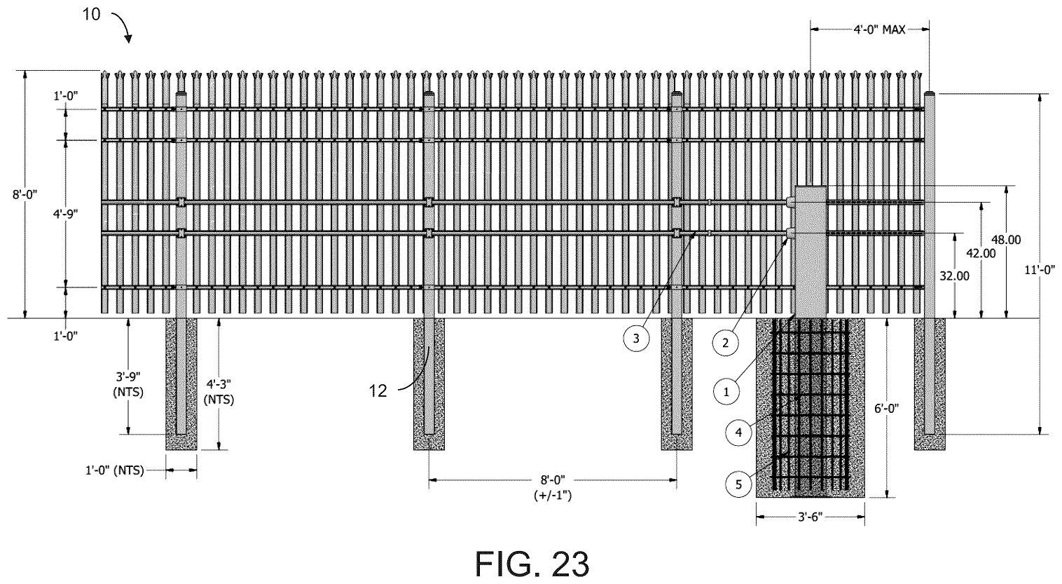

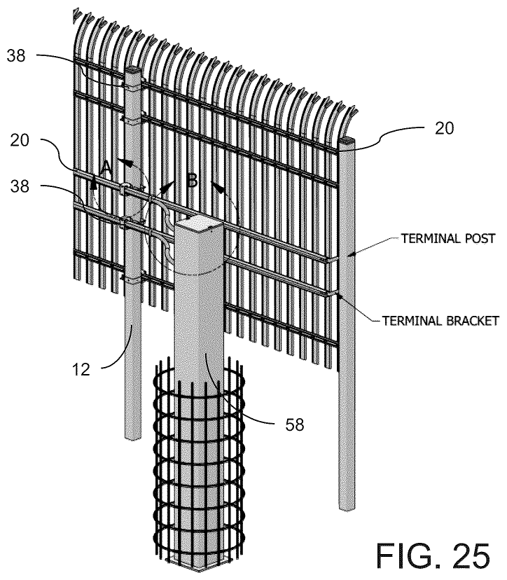

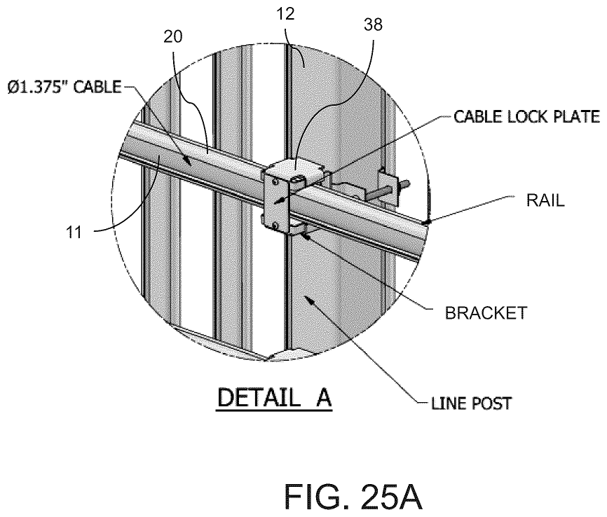

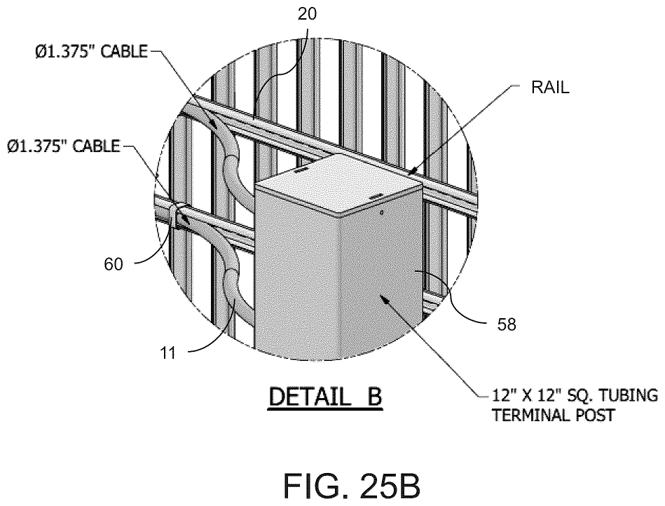

FIGS. 13, 14, 16, 22, 23, 25A, 25B, 26 and 27 include example dimensions for the fencing system 10. For example, the open end of the channel or receiving portion 54 of the retaining portion 42 (e.g., the space between the upper leg 50 and the lower leg 52) may be about 2.25 inches to accommodate the rail 20 having a height of about 1.96 inches and an opening of about 1.4 inches, which accommodates the cable 11 having a diameter of about 1.375 inches (FIGS. 13 and 16). The rail blocker plate 56 may comprise a plate having rounded corners, with a height of about 3.5 inches, a width of about 2 inches and a thickness of about 0.11 inches (FIG. 14). Apertures are receiving holes for the threaded fasteners may be formed through the plate 56 having a diameter of about 0.19 inches, with the upper aperture formed about 0.25 inches from the upper edge and the lower aperture formed about 0.5 inches from the lower edge so that the apertures are about 2.75 inches away from one another. In the illustrated example, the vertical posts 12 may be about 11 feet tall, spaced apart by about 8 feet and sunk into the ground by about 45 inches (FIGS. 22 and 23). Horizontal rails 20 supporting the vertical slats may be disposed at the vertical posts at heights of about 10 inches, 67 inches and 79 inches. Horizontal rails 20 supporting the crash mitigation cables 11 may be disposed at the vertical posts at heights of about 32 inches and 42 inches. The anchor post 58 may be sunk into the ground by about 6 feet and have about 48 inches disposed above ground, with a 12 inch by 12 inch square shape (FIG. 25B).

Changes and modifications in the specifically described embodiments may be carried out without departing from the principles of the present invention, which is intended to be limited only by the scope of the appended claims as interpreted according to the principles of patent law.

1. A fencing system comprising:
a rail member having a slot, wherein the rail member is configured to extend between adjacent posts of the fencing system;
a splicing rail comprising a channel and a flexible tab; and
wherein, with an end portion of the rail member received along the channel of the splicing rail, the flexible tab of the splicing rail flexes at least partially into the channel of the splicing rail and at least partially within the slot of the rail member to preclude the rail member from pulling out of the channel of the splicing rail.

2. The fencing system of claim 1, wherein the adjacent posts are configured to be anchored to the ground, and wherein, with the adjacent posts anchored to the ground, the splicing rail is supported at one post of the adjacent posts.

3. The fencing system of claim 2, wherein the post comprises a passageway through the post, and wherein the splicing rail is received within the passageway of the post, and wherein the splicing rail secures the end portion of the rail member at the post.

4. The fencing system of claim 2, wherein an attachment bracket is disposed at the post, and wherein the attachment bracket comprises a passageway, and wherein the splicing rail is received within the passageway of the attachment bracket, and wherein the splicing rail secures the end portion of the rail member at the post.

5. The fencing system of claim 4, wherein the attachment bracket comprises (i) a first portion that secures the attachment bracket at the post and (ii) a second portion attached to the first portion and comprising the passageway.

6. The fencing system of claim 5, wherein the first portion comprises a band that wraps at least partially about the post to secure the attachment bracket at the post.

7. The fencing system of claim 5, wherein the second portion comprises a C-shaped bracket having (i) a base portion attached to the first portion, (ii) an upper leg extending from the base portion and (iii) a lower leg extending from the base portion and spaced from the upper leg to define the passageway of the attachment bracket between the upper leg and the lower leg.

8. The fencing system of claim 7, wherein, with the splicing rail received within the passageway of the attachment bracket, a retaining plate is attached to an end of the upper leg distal from the base portion and an end of the lower leg distal from the base portion to cover the passageway and retain the splicing rail at the attachment bracket.

9. The fencing system of claim 1, wherein the rail member comprises a channel.

10. The fencing system of claim 9, wherein the rail member comprises a first side and a second side opposite the first side, and wherein the rail member comprises a lengthwise opening along the first side of the rail member, and wherein the slot is formed at the second side of the rail member, and wherein the slot is opposite the lengthwise opening.

11. The fencing system of claim 9, wherein the flexible tab of the splicing rail does not interfere with the channel of the rail member.

12. The fencing system of claim 9, wherein a cable extends along the channel of the rail member.

13. The fencing system of claim 1, wherein the channel of the splicing rail comprises an inner profile that corresponds to an outer profile of the rail.

14. The fencing system of claim 1, wherein the splicing rail comprises a C-shaped rail, and wherein the rail member comprises a C-shaped rail, and wherein the C-shaped rail of the rail member is configured to form a friction fit along the channel of the C-shaped rail of the splicing rail.

15. The fencing system of claim 1, wherein the flexible tab comprises (i) a leading edge that is at least partially connected to the splicing rail and (ii) a trailing edge that is at least partially disconnected from the splicing rail, and wherein, with the trailing edge at least partially within the slot of the rail member, the leading edge flexes as the trailing edge engages the rail member to preclude the rail member from pulling out of the channel of the splicing rail.

16. The fencing system of claim 15, wherein, as the end portion of the rail member is inserted along the channel of the splicing rail in a direction of insertion, the trailing edge moves along the rail member and along the slot of the rail member and the leading edge flexes to move the trailing edge at least partially into the slot of the rail member, and wherein the trailing edge engages the rail member to preclude movement of the rail member in a direction opposite the direction of insertion.

17. The fencing system of claim 16, wherein the trailing edge of the flexible tab is further inboard along the splicing rail in the direction of insertion than the leading edge of the flexible tab.

18. The fencing system of claim 1, wherein the flexible tab comprises a C-shaped tab integrally formed with a side of the splicing rail.

19. The fencing system of claim 1, wherein the flexible tab is cut from a side of the splicing rail.

20. The fencing system of claim 1, further comprising a second rail member having a second slot, and wherein, with an end portion of the second rail member received along the channel of the splicing rail, a second flexible tab of the splicing rail flexes at least partially into the channel of the splicing rail and at least partially within the second slot of the second rail member to preclude the second rail member from pulling out of the channel of the splicing rail, and wherein the rail member and the second rail member extend in opposing directions from the splicing rail.

21. The fencing system of claim 20, wherein the splicing rail receives the end portion of the rail member and the end portion of the second rail member at a position between the adjacent posts of the fencing system.

22. The fencing system of claim 20, wherein the splicing rail receives the end portion of the rail member and the end portion of the second rail member at one post of the adjacent posts of the fencing system.
